(19) United States
(12) Patent Application Publication
(10) Pub. No.: US 2026/0261023 A1
(43) Pub. Date: Sep. 3, 2026

(54) ACCELERATING ELECTROLYTE FILLING OF BATTERY CELLS USING ELECTROLYTE VAPOR PRETREATMENT

(71) Applicant: GM GLOBAL TECHNOLOGY OPERATIONS LLC, Detroit, MI (US)

(72) Inventors: Xingcheng XIAO, Troy, MI (US); Sean Coyle, macomb, MI (US); Joel G. Toner, Imlay City, MI (US); Daniel Gerardo Gonzalez, Lake Orion, MI (US); John P. Healy, Rochester Hills, MI (US); Ruchira Dharmasena, Bloomfield Hills, MI (US)

(21) Appl. No.: 19/069,001

(22) Filed: Mar. 3, 2025

(51) Int. Cl. H01M 50/618; H01M 10/0569

(52) U.S. Cl. CPC H01M 50/618; H01M 10/0569; H01M 2300/0051

(57) ABSTRACT

A system for filling a battery cell with electrolyte includes an electrolyte filling chamber configured to enclose a battery cell including an electrolyte filling port. A first heater is configured to heat the electrolyte filling chamber to a predetermined temperature. A vacuum source is configured to control a vacuum in the electrolyte filling chamber. A vapor generator is configured to supply a vapor from at least one of a liquid electrolyte and a liquid electrolyte co-solvent in the electrolyte filling chamber for a predetermined period. An electrolyte hopper is configured to fill the battery cell with the liquid electrolyte after the predetermined period. The predetermined temperature is greater than 40º C. and vacuum is less than 1bar. The vapor generator is located inside or outside of the electrolyte filling chamber.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to battery cells, and more particularly to systems and methods for adding electrolyte to battery cells.

Electric vehicles (EVs) such as battery electric vehicles (BEVs), hybrid vehicles, and/or fuel cell vehicles include one or more electric machines and a battery system including one or more battery cells, modules, and/or packs. A power control system is used to control charging and/or discharging of the battery system during charging and/or driving.

Battery cells include cathode electrodes, anode electrodes, and separators arranged in a battery cell enclosure. The cathode electrodes include a cathode active material layer arranged on a cathode current collector. The anode electrodes include an anode active material layer arranged on an anode current collector. After arranging the cathode electrodes, anode electrodes, and separators in the battery cell enclosure, the battery cell enclosure is enclosed and liquid electrolyte is added to the enclosure through an electrolyte filling port.

### SUMMARY

A system for filling a battery cell with electrolyte includes an electrolyte filling chamber configured to enclose a battery cell including an electrolyte filling port. A first heater is configured to heat the electrolyte filling chamber to a predetermined temperature. A vacuum source is configured to control a vacuum in the electrolyte filling chamber. A vapor generator is configured to supply a vapor from at least one of a liquid electrolyte and a liquid electrolyte co-solvent in the electrolyte filling chamber for a predetermined period. An electrolyte hopper is configured to fill the battery cell with the liquid electrolyte after the predetermined period.

In other features, the predetermined temperature is greater than 40ºC and vacuum is less than 1bar. The vapor generator is located outside of the electrolyte filling chamber. The vapor generator includes a second heater to heat the at least one of the liquid electrolyte and the liquid electrolyte co-solvent to a temperature greater than 60ºC. The vapor generator includes a container located inside of the electrolyte filling chamber and including the at least one of the liquid electrolyte and the liquid electrolyte co-solvent.

In other features, the battery cell includes an enclosure selected from a group consisting of prismatic, cylindrical, and pouch. The predetermined period is greater than 1 minute. A positioning device is configured to arrange a nozzle of an electrolyte hopper in the electrolyte filling port during filling.

In other features, a plurality of the battery cell is arranged in the electrolyte filling chamber. The vapor is generated from the liquid electrolyte co-solvent. The liquid electrolyte co-solvent is selected from a group consisting of dimethyl carbonate (DMC), ethyl methyl carbonate (EC), diethyl carbonate (DEC), propylene carbonate (PC), and combinations thereof.

A method for filling a battery cell includes heating an electrolyte filling chamber to a predetermined temperature; arranging a battery cell including an electrolyte filling port in the chamber; drawing a vacuum in the chamber; generating a vapor from at least one of a liquid electrolyte and a liquid electrolyte co-solvent; supplying the vapor in the chamber for a predetermined period; and after the predetermined period, filling the battery cell with the liquid electrolyte.

In other features, the predetermined temperature is greater than 40ºC and vacuum is less than 1 bar. The method includes generating the vapor using a vapor generator located outside of the electrolyte filling chamber. The vapor generator heats the at least one of the liquid electrolyte and the liquid electrolyte co-solvent to a temperature greater than 60ºC.

The method includes generating the vapor by arranging a container including the at least one of the liquid electrolyte and the liquid electrolyte co-solvent inside of the electrolyte filling chamber. The battery cell includes an enclosure selected from a group consisting of prismatic, cylindrical, and pouch.

In other features, the predetermined period is greater than 1 minute. Filling the battery cell with the liquid electrolyte includes lowering a nozzle of an electrolyte hopper into the electrolyte filling port during filling.

In other features, a plurality of the battery cell is arranged in the electrolyte filling chamber. The vapor is generated from the liquid electrolyte co-solvent. The liquid electrolyte co-solvent is selected from a group consisting of dimethyl carbonate (DMC), ethyl methyl carbonate (EC), diethyl carbonate (DEC), propylene carbonate (PC), and combinations thereof.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example of a battery cell including A anode electrodes, C cathode electrodes, S separators, and liquid electrolyte according to the present disclosure;

FIG. 2 is a perspective view of an example of an enclosure for a battery cell according to the present disclosure;

FIG. 3 is a flowchart of an example of a method for filling a battery cell with liquid electrolyte;

FIG. 4 is a flowchart of an example of a method for pretreating the battery cell with vapor prior to filling the battery cell with liquid electrolyte according to the present disclosure;

FIGS. 5A and 5B are functional block diagrams of an example of a system for pretreating the battery cell with vapor using a vapor generator arranged outside of an electrolyte filling chamber prior to filling the battery cell according to the present disclosure; and

FIGS. 6A and 6B are functional block diagrams of an example of a system for pretreating the battery cell with vapor using a vapor generator arranged inside of an electrolyte filling chamber prior to filling the battery cell according to the present disclosure.

In the drawings, reference numbers may be reused to identify similar and/or identical elements.

### DETAILED DESCRIPTION

While battery cells according to the present disclosure are shown in the context of electric vehicles, the battery cells can be used in stationary applications and/or in other applications.

Electrolyte filling of battery cells is an important step during battery manufacturing that can improve battery cell quality and/or avoid localized lithium plating. However, electrolyte filling is time consuming and cost intensive. In some examples, an electrolyte filling port is small (e.g., < 3mm in diameter) and the electrolyte filling process takes approximately 24 hours. Accelerating the electrolyte filling process and reducing the wetting time can improve manufacturing efficiency and reduce aging time.

General approaches to improve wettability include adjusting surface tension and viscosity of the electrolyte by adding additives or heating; surface modification of the electrodes and/or separator; generating negative pressure; and/or applying an electrochemical potential to generate the electrocapillary forces.

Systems and methods according to the present disclosure enable quick and uniform filling of battery cells with electrolyte to improve manufacturing efficiency. Before performing electrolyte filling, the battery cells are pretreated with electrolyte vapor or electrolyte co-solvent vapor. The vapor condenses in pore surfaces of the battery cells due to capillary condensation. The wetted pore surfaces significantly improve wettability of the battery cells and accelerate the subsequent electrolyte filling process. In some examples, exposure to the vapor prior to electrolyte filling reduces electrolyte filling time by greater than 30% (and in some circumstances more than 50%).

The molecular interaction between electrolyte or electrolyte co-solvent vapor and pore surfaces of battery cell components accelerates subsequent wetting during filling. Vacuum pressure is controlled during vapor exposure to promote capillary condensation and reduce the energy barrier for vapor to penetrate micropores and/or nanopores. In some examples, the amount of condensed vapor added is less than < 1 wt% of the total electrolyte to minimize the impact on electrolyte composition. The large heat mass of the battery cell (which needs a long time to heat up) is used to facilitate the solvent condensation at a relatively lower temperature.

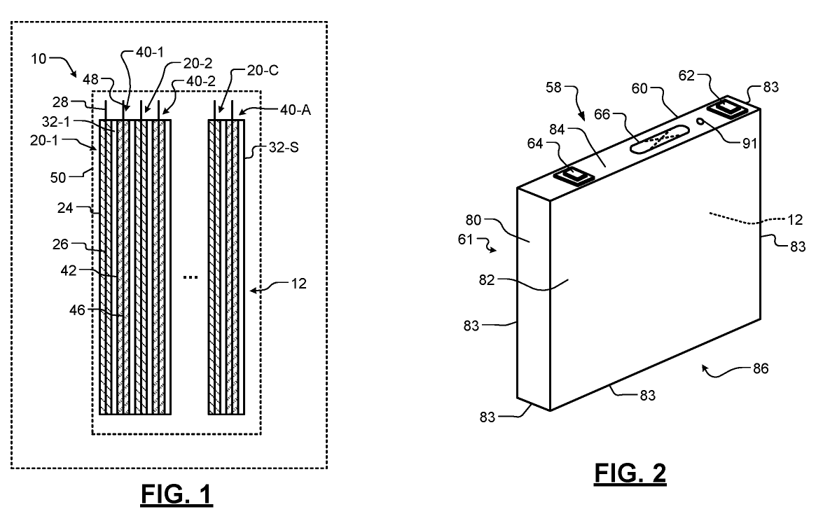

Referring now to FIG. 1, a battery cell 10 includes C cathode electrodes 20, A anode electrodes 40, and S separators 32 arranged in a predetermined sequence in a battery cell stack 12, where C, S and A are integers greater than zero. The C cathode electrodes 20-1, 20-2, ..., and 20-C include cathode active material layers 24 arranged on one or both sides of a cathode current collector 26. The A anode electrodes 40-1, 40-2, ..., and 40-A include anode active material layers 42 arranged on one or both sides of the anode current collectors 46. In some examples, the A anode electrodes 40 and the C cathode electrodes 20 exchange lithium ions during charging/discharging.

In some examples, the cathode active material layers 24 and/or the anode active material layers 42 comprise coatings including one or more active materials, one or more conductive additives, and/or one or more binder materials that are applied to the current collectors (e.g., using a wet or dry roll-to-roll process), although other manufacturing methods can be used. In some examples, the cathode current collector 26 and/or the anode current collector 46 comprises metal foil, metal mesh, perforated metal, 3 dimensional (3D) metal foam, and/or expanded metal. In some examples, the current collectors are made of one or more materials selected from a group consisting of copper, stainless steel, brass, bronze, zinc, aluminum, and/or alloys thereof. External tabs 28 and 48 are connected to the current collectors of the cathode electrodes and anode electrodes, respectively, and can be arranged on the same or different sides of the battery cell stack 12. The external tabs 28 and 48 are connected to terminals of the battery cells.

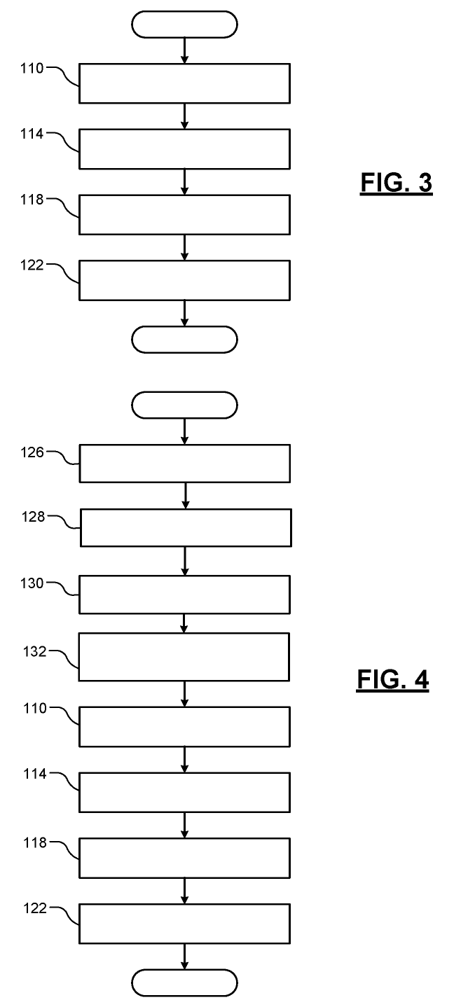

Referring now to FIG. 2, a battery cell 58 includes a battery cell enclosure 60. In some examples, the enclosure 60 has a prismatic shape with rectangular cross-sections in x-, y- and z-axis planes, although other enclosure shapes such as cylindrical or pouch enclosures can be used. In some examples, the battery cell enclosure 60 includes an enclosure body 61 including sides 80 corresponding to narrow faces and sides 82 corresponding to wide faces. The enclosure body 61 defines an open-ended rectangular prism. In some examples, the battery cell enclosure 60 includes a lid portion 84 and a bottom portion 86. In other examples, the bottom portion 86 is attached after the enclosure body 61 is formed. Edges 83 are arranged between the sides 80 and 82, the sides 80 and 82 and a lid portion 84, the sides 80 and 82 and the bottom portion 86.

The lid portion 84 and optionally the bottom portion 86 are attached to the enclosure body 61 to enclose top and the bottom openings of the enclosure body 61, respectively. The battery cell 58 includes external terminals 62 and 64 that pass through the lid portion 84. The battery cell stack 12 of the C cathode electrodes 20, the A anode electrodes 40, and the S separators 32 is arranged in the battery cell enclosure 60.

The external terminals 62 and 64 are connected to external tabs 28 and 48 of the C cathode electrodes 20 and the A anode electrodes 40, respectively. The lid portion 84 (and/or the bottom portion 86) includes a pressure-based vent cap 66. The pressure-based vent cap 66 is configured to release vent gases when pressure within the inner enclosure is greater than a predetermined pressure. The lid portion 84 includes an electrolyte filling port 91.

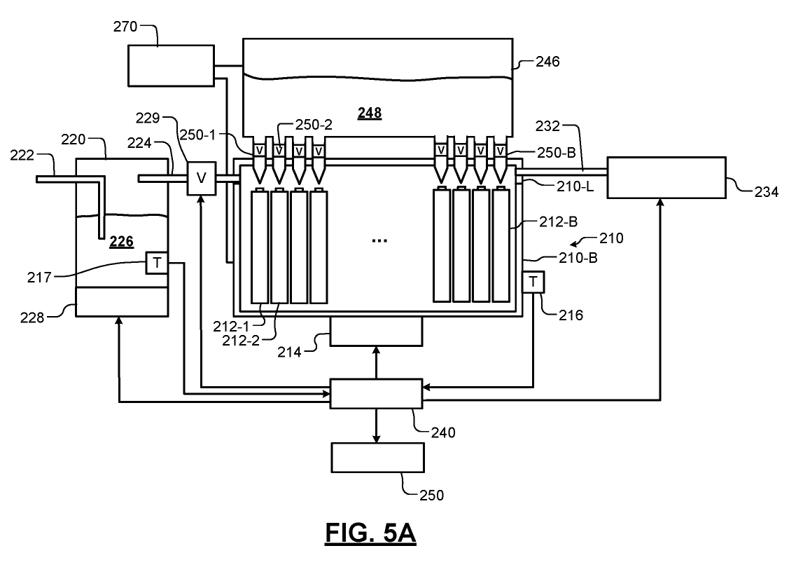

Referring now to FIG. 3, after manufacturing the battery cell, electrolyte fluid is typically dispensed at 110 into the enclosure of the battery cell through the electrolyte filling port 91. At 114, the electrolyte filling port 91 is closed. At 118, the battery cell is stored for a predetermined period to allow wetting. At 122, formation of the battery cell is performed.

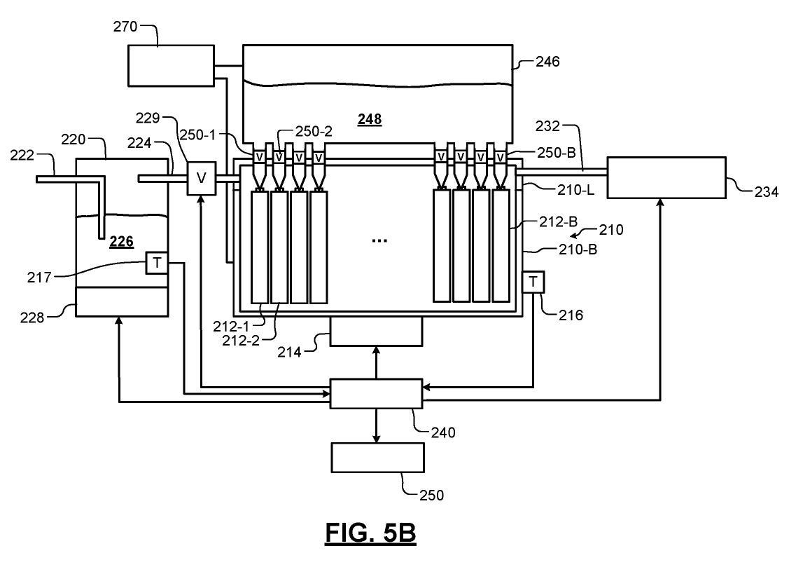

Referring now to FIG. 4, a method for filling a battery cell according to the present disclosure is shown. Prior to dispensing the electrolyte fluid at 110, the battery cell is pretreated with electrolyte vapor (from either liquid electrolyte or liquid electrolyte co-solvent) for a predetermined period. Exposure to the vapor wets interior surfaces of the battery cells and reduces the time required to dispense the electrolyte fluid into the enclosure of the battery cell through the electrolyte filling port 91.

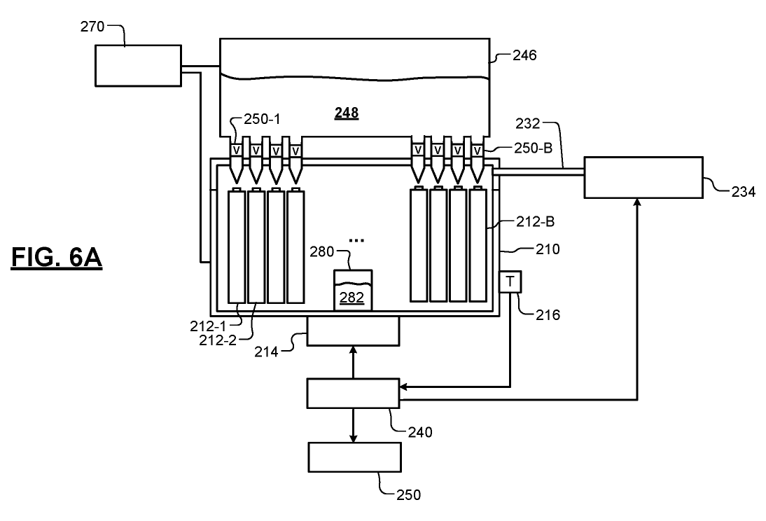

Referring now to FIGS. 5A and 5B, a system for filling one or more battery cells with liquid electrolyte after pretreatment with vapor is shown. In FIG. 5A, a vapor generator 220 is arranged outside of an electrolyte filling chamber 210. The electrolyte filling chamber 210 includes a lid 210-L and a lower body 210-B. In some examples, a heater 214 is used to heat the electrolyte filling chamber 210. In some examples, the heater heats the electrolyte filling chamber 210 to a temperature greater than 40ºC (e.g. 60ºC) to avoid condensation on walls of the electrolyte filling chamber 210. In some examples, the electrolyte filling chamber 210 is heated before B battery cells 212-1, 212-2, …, and 212-B are arranged therein, where B is an integer greater than zero.

The B battery cells 212-1, 212-2, …, and 212-B are arranged in the lower body 210-B of the electrolyte filling chamber 210. The lid 210-L encloses the lower body 210-B. A seal such as an O-ring seal (not shown) may be arranged between the lid 210-L and the lower body 210-B to provide a vacuum seal.

A pump or vacuum source 234 evacuates the electrolyte filling chamber 210 prior to exposure to the vapor. In some examples, the electrolyte filling chamber 210 is pumped down to a vacuum less than 1 bar (e.g., 400 mbar) to remove air from the B battery cells 212-1, 212-2, …, and 212-B. The large heat mass of the B battery cells 212-1, 212-2, …, and 212-B ensures that internal components of the B battery cells 212-1, 212-2, …, and 212-B have a lower temperature to facilitate condensation. The B battery cells 212-1, 212-2, …, and 212-B are exposed to the vapor for a predetermined period. In some examples, the predetermined period is greater than 1 minute.

The vapor generator 220 stores a liquid 226 (liquid electrolyte and/or a liquid electrolyte co-solvent). A heater 228 may be used to heat the liquid 226 to generate vapor. In some examples, the heater 228 heats the vapor generator 220 to a temperature greater than 60ºC. A fill tube 222 may be provided to selectively add electrolyte to the vapor generator 220. The vapor is directed through a conduit 224 and valve 229 (when open) to supply vapor into the electrolyte filling chamber 210.

A controller 240 may be used to control the vapor treatment and filling process. The controller 240 exposes the B battery cells 212-1, 212-2, …, and 212-B to vapor prior to filling the B battery cells 212-1, 212-2, …, and 212-B with liquid electrolyte. In some examples, the controller 240 controls the heater 214 and/or the heater 228 in response to temperature sensors 215 and/or 217, respectively. In other examples, open-loop heater control is used.

In some examples, the controller 240 controls the pump or vacuum source 234 to vary vacuum pressure within the electrolyte filling chamber 210. In some examples, a three-way valve (not shown) may be arranged in the conduit 232 connecting the electrolyte filling chamber 210 to the pump or vacuum source 234 or to atmosphere. In some examples, a pressure sensor (not shown) may be arranged inside of the electrolyte filling chamber 210 to provide increased control of vacuum in the electrolyte filling chamber 210.

A liquid electrolyte hopper 246 stores and dispenses liquid electrolyte 248. B nozzles 260-1, 260-2, …, and 260-B extend downwardly from the liquid electrolyte hopper 246 and include B valves 250-1, 250-2, …, and 250-B to control dispensing of the liquid electrolyte. The controller 240 fills the B battery cells with liquid electrolyte after the B battery cells 212-1, 212-2, …, and 212-B are exposed to vapor.

In some examples, a position of one or both of the electrolyte filling chamber 210 and/or the liquid electrolyte hopper 246 is adjusted by a positioning device 270 after vapor exposure. During filling, tips of the nozzles 260-1, 260-2, …, and 260-B of the liquid electrolyte hopper 246 are moved into or immediately adjacent to the electrolyte filling ports 91 (shown in FIG. 2).

In FIG. 5A, the tips of the nozzles 260-1, 260-2, …, and 260-B of the liquid electrolyte hopper 246 are spaced by a predetermined distance above the B battery cells 212-1, 212-2, …, and 212-B to allow free flow of vapor into the electrolyte filling ports 91. In FIG. 5B, the tips of the nozzles 260-1, 260-2, …, and 260-B of the liquid electrolyte hopper 246 are located in or in close proximity to the electrolyte filling ports 91 to fill the B battery cells 212-1, 212-2, …, and 212-B with electrolyte.

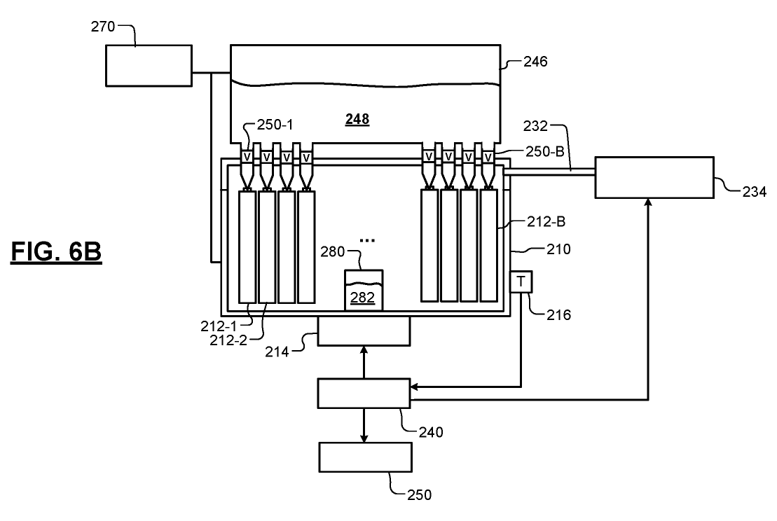

Referring now to FIGS. 6A and 6B, a simplified system is shown. The vapor generator includes a container 280 storing liquid electrolyte 282 that is located in the electrolyte filling chamber 210. The pump or vacuum source 234 evacuates the electrolyte filling chamber 210 and heat from the electrolyte filling chamber 210 heats the container 280 including liquid electrolyte 282 to generate electrolyte vapor. After exposure to the electrolyte vapor for a predetermined period, vacuum within the electrolyte filling chamber 210 is eliminated and the valves 250-1, 250-2, …, and 250-B supply liquid electrolyte into the B battery cells 212-1, 212-2, …, and 212-B.

In FIG. 6A, the tips of the nozzles 260-1, 260-2, …, and 260-B of the liquid electrolyte hopper 246 are spaced by a predetermined distance above the B battery cells 212-1, 212-2, …, and 212-B to allow free flow of vapor into the electrolyte filling ports 91. In FIG. 6B, the tips of the nozzles 260-1, 260-2, …, and 260-B of the liquid electrolyte hopper 246 are located in or in close proximity to the electrolyte filling ports 91 to fill the B battery cells 212-1, 212-2, …, and 212-B with electrolyte.

In some examples, the electrolyte co-solvent is selected from a group consisting of dimethyl carbonate (DMC), ethyl methyl carbonate (EC), diethyl carbonate (DEC), propylene carbonate (PC), and combinations thereof.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A system for filling a battery cell with electrolyte, comprising:
an electrolyte filling chamber configured to enclose a battery cell including an electrolyte filling port;
a first heater configured to heat the electrolyte filling chamber to a predetermined temperature;
a vacuum source configured to control a vacuum in the electrolyte filling chamber;
a vapor generator configured to supply a vapor from at least one of a liquid electrolyte and a liquid electrolyte co-solvent in the electrolyte filling chamber for a predetermined period; and
an electrolyte hopper configured to fill the battery cell with the liquid electrolyte after the predetermined period.

2. The system of claim 1, wherein the predetermined temperature is greater than 40ºC. and vacuum is less than 1bar.

3. The system of claim 1, wherein the vapor generator is located outside of the electrolyte filling chamber.

4. The system of claim 3, wherein the vapor generator includes a second heater to heat the at least one of the liquid electrolyte and the liquid electrolyte co-solvent to a temperature greater than 60ºC.

5. The system of claim 1, wherein the vapor generator includes a container located inside of the electrolyte filling chamber and including the at least one of the liquid electrolyte and the liquid electrolyte co-solvent.

6. The system of claim 1, wherein battery cell includes an enclosure selected from a group consisting of prismatic, cylindrical, and pouch.

7. The system of claim 1, wherein the predetermined period is greater than 1 minute.

8. The system of claim 1, further comprising a positioning device configured to arrange a nozzle of an electrolyte hopper in the electrolyte filling port during filling.

9. The system of claim 1, wherein a plurality of the battery cell is arranged in the electrolyte filling chamber.

10. The system of claim 1, wherein:
the vapor is generated from the liquid electrolyte co-solvent, and
the liquid electrolyte co-solvent is selected from a group consisting of dimethyl carbonate (DMC), ethyl methyl carbonate (EC), diethyl carbonate (DEC), propylene carbonate (PC), and combinations thereof.

11. A method for filling a battery cell, comprising:
heating an electrolyte filling chamber to a predetermined temperature;
arranging a battery cell including an electrolyte filling port in the chamber;
drawing a vacuum in the chamber;
generating a vapor from at least one of a liquid electrolyte and a liquid electrolyte co-solvent;
supplying the vapor in the chamber for a predetermined period; and
after the predetermined period, filling the battery cell with the liquid electrolyte.

12. The method of claim 11, wherein the predetermined temperature is greater than 40ºC. and vacuum is less than 1 bar.

13. The method of claim 11, further comprising generating the vapor using a vapor generator located outside of the electrolyte filling chamber.

14. The method of claim 13, wherein the vapor generator heats the at least one of the liquid electrolyte and the liquid electrolyte co-solvent to a temperature greater than 60ºC.

15. The method of claim 11, further comprising generating the vapor by arranging a container including the at least one of the liquid electrolyte and the liquid electrolyte co-solvent inside of the electrolyte filling chamber.

16. The method of claim 11, wherein battery cell includes an enclosure selected from a group consisting of prismatic, cylindrical, and pouch.

17. The method of claim 11, wherein the predetermined period is greater than 1 minute.

18. The method of claim 11, wherein filling the battery cell with the liquid electrolyte includes lowering a nozzle of an electrolyte hopper into the electrolyte filling port during filling.

19. The method of claim 11, wherein a plurality of the battery cell is arranged in the electrolyte filling chamber.

20. The method of claim 11, wherein:
the vapor is generated from the liquid electrolyte co-solvent, and
the liquid electrolyte co-solvent is selected from a group consisting of dimethyl carbonate (DMC), ethyl methyl carbonate (EC), diethyl carbonate (DEC), propylene carbonate (PC), and combinations thereof.
